(19) United States
(12) Patent Application Publication
(10) Pub. No.: US 2025/0069247 A1
(43) Pub. Date: Feb. 27, 2025

(54) TEMPORAL CONSISTENCY VIA BACKBONE FEATURE FUSION FOR PIXEL-LEVEL PREDICTION TASKS

(71) Applicant: SAMSUNG ELECTRONICS CO., LTD., Suwon-si (KR)

(72) Inventors: Haoyu REN, San Diego, CA (US); Mostafa EL-KHAMY, San Diego, CA (US); Jungwon LEE, San Diego, CA (US); Hai SU, San Diego, CA (US); Qingfeng LIU, San Diego, CA (US)

(73) Assignee: SAMSUNG ELECTRONICS CO., LTD., Suwon-si (KR)

(21) Appl. No.: 18/943,520

(22) Filed: Nov. 11, 2024

Related U.S. Application Data
(63) Continuation-in-part of application No. 18/676,414, filed on May 28, 2024.
Application No. 18/676,414 is a continuation of application No. 18/080,599, filed on Dec. 13, 2022, now Pat. No. 11,995,856.
Application No. 18/080,599 is a continuation of application No. 16/841,618, filed on Apr. 6, 2020, now Pat. No. 11,527,005.
(60) Provisional application No. 62/877,246, filed on Jul. 22, 2019.
(60) Provisional application No. 63/605,226, filed on Dec. 1, 2023.

(51) Int. Cl. G06T 7/579; G06T 3/18; G06T 7/194

(52) U.S. Cl. CPC G06T 7/579; G06T 7/194; G06T 3/18; G06T 2207/10016; G06T 2207/20021; G06T 2207/20084

(57) ABSTRACT

Methods and systems for performing video prediction, including obtaining an input frame from among a plurality of frames included in an input video; extracting a first feature map by providing the input frame to a first plurality of feature extraction layers and a first strided convolutional layer included in an encoder; providing the first feature map and at least one neighboring first feature map corresponding to at least one neighboring frame to a first fusion module included in the encoder; fusing the first feature map with the at least one neighboring first feature map to generate a fused first feature map using the first fusion module; generating a prediction corresponding to the input frame based on the fused first feature map using a decoder; and performing a video prediction task using the prediction.

### CROSS-REFERENCE TO RELATED APPLICATION

This application claims the priority benefit under 35 U.S.C. § 119 (e) of U.S. Provisional Application No. 63/605,226, filed on Dec. 1, 2023, and is a continuation-in-part of U.S. application Ser. No. 18/676,414, filed on May 28, 2024, which is a continuation of U.S. application Ser. No. 18/080,599, filed on Dec. 13, 2022, which is a continuation of U.S. application Ser. No. 16/841,618, filed on Apr. 6, 2020, which claims the priority benefit of U.S. Provisional Application No. 62/877,246, filed on Jul. 22, 2019, the disclosures of which are incorporated by reference in their entireties as if fully set forth herein.

### TECHNICAL FIELD

The disclosure generally relates to video prediction. More particularly, the subject matter disclosed herein relates to improving temporal consistency by fusing feature maps corresponding to a current video frame with feature maps corresponding to temporally-neighboring frames.

### SUMMARY

Video semantic segmentation is an important task for many downstream computer vision tasks. Deep neural network (DNN) based video semantic segmentation is a dense prediction task that aims to classify each pixel in the input frames into its corresponding predefined categories. DNNs for video semantic segmentation may be adapted from DNNs for single image semantic segmentation tasks. By applying the network to each frame of the video independently, a pixel-wise dense prediction may be obtained for the whole video.

However, these video semantic segmentation networks may generate temporally inconsistent predictions for consecutive frames. This may be partially due to the strided convolution in the backbone that can generate inconsistent features when the same content is shifted by a few pixels (i.e. image content in consecutive frames). This temporal inconsistency in the features may cause flickering predictions in the output, for example the predicted labels, which may render the video semantic segmentation networks unusable.

To solve this problem, some approaches incorporate an optical flow module or temporal transformer operations in the video semantic segmentation network to improve temporal consistency. The optical flow module may require operations such as optical flow prediction and frame warping, and the temporal transformer operations may involve heavy matrix multiplications, all of which introduce heavy computational cost. In addition, these approaches may be occasionally detrimental, for example by generating a mistaken optical flow predictions may undermine an original correct prediction.

To overcome these issues, systems and methods are described herein for counteracting the effect of the strided convolution layers by fusing features from neighboring consecutive frames so that the temporal consistency of the prediction is improved. Because embodiments may not rely on operations such as optical flow prediction, warping, or transformer computation, computational cost may be reduced compared to the approaches discussed above.

In an embodiment, a method of performing video prediction comprises obtaining an input frame from among a plurality of frames included in an input video; extracting a first feature map by providing the input frame to a first plurality of feature extraction layers and a first strided convolutional layer included in an encoder; providing the first feature map and at least one neighboring first feature map corresponding to at least one neighboring frame to a first fusion module included in the encoder; fusing the first feature map with the at least one neighboring first feature map to generate a fused first feature map using the first fusion module; generating a prediction corresponding to the input frame based on the fused first feature map using a decoder; and performing a video prediction task using the prediction.

In an embodiment, a system for performing video prediction comprises an encoder configured to: obtain an input frame from among a plurality of frames included in an input video, extract a first feature map by providing the input frame to a first plurality of feature extraction layers and a first strided convolutional layer included in the encoder, provide the first feature map and at least one neighboring first feature map corresponding to at least one neighboring frame to a first fusion module included in the encoder, fuse the first feature map with the at least one neighboring first feature map to generate a fused first feature map using the first fusion module; a decoder configured to generate a prediction corresponding to the input frame based on the fused first feature map; and at least one video processor configured to perform a video prediction task using the prediction.

### BRIEF DESCRIPTION OF DRAWING

In the following section, the aspects of the subject matter disclosed herein will be described with reference to exemplary embodiments illustrated in the figures, in which:

FIG. 1 is a block diagram showing a video processing system, according to embodiments.

FIG. 2 is an illustration showing an example of results of video processing which may be performed by a video processing system, according to embodiments.

FIG. 3 is a diagram showing an example of temporal inconsistency due to strided convolution, according to embodiments.

FIGS. 4A-4B are—block diagrams showing example arrangements of an encoder, according to embodiments.

FIG. 5 is a block diagram of an example implementation of a fusion module, according to embodiments.

FIG. 6 is a block diagram of an example implementation of a fusion module, according to embodiments.

FIG. 7 is a block diagram of an example implementation of a fusion module, according to embodiments.

FIG. 8 is a flow chart of a process for performing video prediction, according to embodiments.

FIG. 9 is a block diagram of an electronic device in a network environment, according to an embodiment.

FIG. 10 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

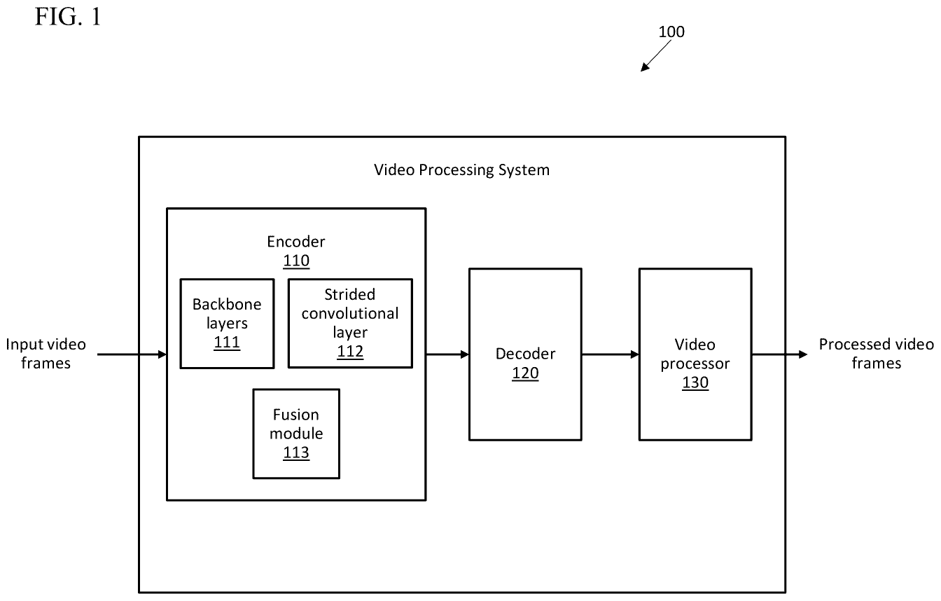

FIG. 1 is a block diagram showing a video processing system, according to embodiments. According to embodiments, the video processing system 100 may be used to perform dense prediction tasks for video, for example tasks such as video semantic segmentation, video super resolution processing, video denoising, etc. Video semantic segmentation may refer to the task of predicting the class of each pixel in each frame of an input video.

As shown in FIG. 1, the video processing system 100 may include an encoder 110, a decoder 120, and a video processor 130. The encoder 110 may include one or more backbone layers 111, strided convolution layers 112, and fusion modules 113. In embodiments the backbone layers 111 may be used to extract features, and therefore may be referred to as feature extraction layers.

In embodiments, one or more of the encoder 110, the decoder 120, the backbone layers 111, the strided convolution layers 112, and the fusion modules 113 may be, may include, or may be included in, for example, a machine-learning model such as a neural network model. For example, the encoder 110 and the decoder 120 may be, may include, or may be included in one from among a convolutional neural network (CNN) and a deep neural network (DNN), but embodiments are not limited thereto.

In embodiments, a neural network model may refer to a type of computer algorithm capable of learning specific patterns without being explicitly programmed, but through iterations over known data. A neural network model may refer to a cognitive model that includes input nodes, hidden nodes, and output nodes. Nodes in the neural network model may have an activation function that computes whether the node is activated based on the output of previous nodes. Training the system may involve supplying values for the inputs, and modifying edge weights and activation functions (algorithmically or randomly) until the result closely approximates a set of desired outputs.

An artificial neural network model may refer to a hardware or a software component which includes a number of connected nodes (e.g., artificial neurons), which may loosely correspond to the neurons in a human brain. Each connection, or edge, may transmit a signal from one node to another (like the physical synapses in a brain). When a node receives a signal, the node may process the signal and then transmit the processed signal to other connected nodes. In some embodiments, the signals between nodes may include real numbers, and the output of each node may be computed by a function of the sum of its inputs. Each node and edge may be associated with one or more node weights that determine how the signal is processed and transmitted. During the training process, these weights may be adjusted to improve the accuracy of the result (e.g., by minimizing a loss function which corresponds in some way to the difference between the current result and the target result). The weight of an edge may increase or decrease the strength of the signal transmitted between nodes. In some cases, nodes may have a threshold below which a signal is not transmitted at all. In some examples, the nodes may be aggregated into layers. Different layers may perform different transformations on their inputs. The initial layer may be referred to as the input layer and the last layer may be referred to as the output layer. In some cases, signals may traverse certain layers multiple times.

In embodiments, the encoder 110 may be trained to receive input video frames and generate feature maps corresponding to the input video frames, for example by using one or more of the backbone layers 111, strided convolution layers 112, and fusion modules 113, examples of which are described in more detail below. The feature maps may be provided to the decoder 120, which may generate a prediction result based on the feature maps. For example, based on the video processing system 100 being used to perform video semantic segregation, the decoder 120 may be trained to use the feature maps to generate a prediction corresponding to the input video. For example, the prediction may be a mask indicating a predicted class for each pixel in each frame of the input video. In embodiments, the mask may be provided to the video processor 130, which may perform a prediction task such as a video semantic segmentation task based on the input video and the masks corresponding to the frames of the input video. However, embodiments are not limited thereto, and in some embodiments the prediction may be, for example, at least one of an image and/or a tensor.

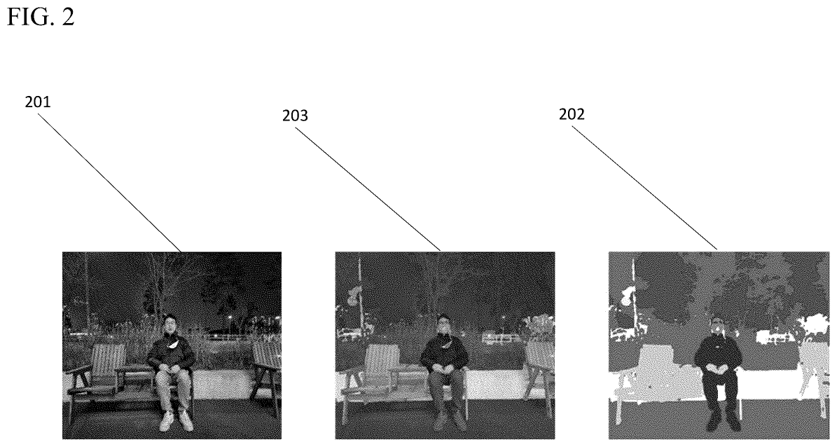

FIG. 2 is an illustration showing an example of results of video processing which may be performed by a video processing system, according to embodiments. Based on an input frame 201 included in the input video, the encoder 110 and the decoder 120 may be used to generate a prediction such as a mask 202 corresponding to the frame 201. In embodiments, the video processor 130 may then combine the input frame 201 and the mask 202 to generate a combined image 203, which may indicate a predicted class corresponding to each pixel of the input frame 201.

Some approaches to video dense prediction tasks may suffer from temporal inconsistency issues due to imperfection of the predicted results by a deep neural network. This temporal inconsistency may include inconsistent predictions for consecutive video frames, which may be partially caused by limited representation capacity of the deenetwork, for example due to the use of strided convolutional layers.

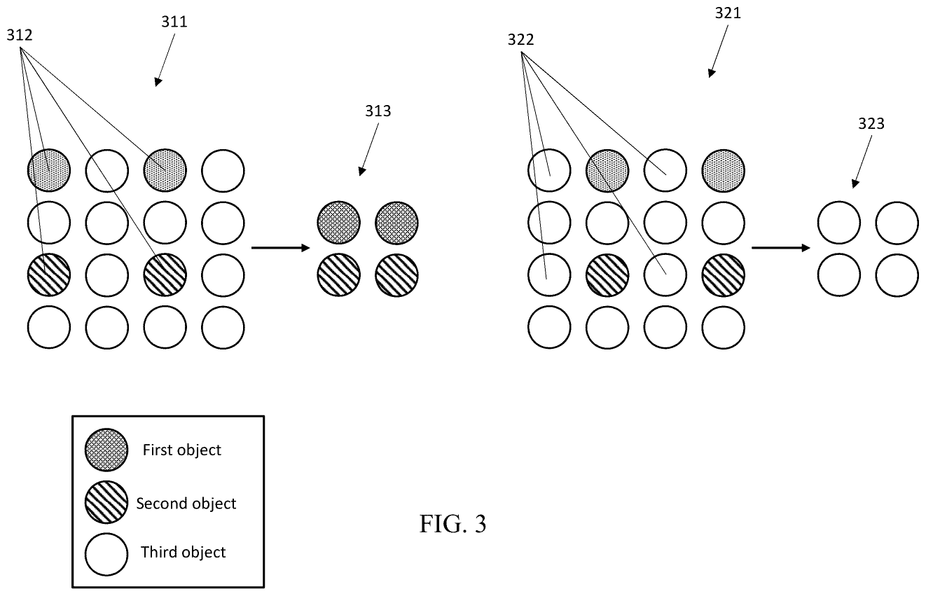

FIG. 3 is a diagram showing an example of temporal inconsistency due to strided convolution, according to embodiments. During strided convolution, a sliding filter may be applied to input data such as a frame or a feature map in order to downsample the input data to reduce the computation complexity of subsequent calculations. For example, the sliding filter may perform downsampling by skipping some pixels as it moves over the input frame.

In the example shown in FIG. 3, a strided convolution operation with a downsampling rate of 2 may be performed on a 4×4 feature map 311 corresponding to a first frame, to produce a downsampled feature map 313. As can be seen in FIG. 3, the downsampled feature map 313 may capture features 312 corresponding to a first object and a second object, while skipping other pixels corresponding to a third object. The same strided convolution operation may then be performed on a neighboring feature map 321 corresponding to a second frame, which may be a neighboring frame with respect to the first frame, to produce a neighboring downsampled feature map 323. The second frame may be a frame that temporally precedes or temporally succeeds the first frame, and as a result the objects included in the second frame may be shifted slightly with respect to the first frame. Therefore, the downsampled feature map 323 may only capture features 322 corresponding to the third object, while skipping other pixels corresponding to the first object and the second object. As a result, if video semantic segmentation is performed on a strictly frame-by-frame basis, with no consideration of neighboring frames, the classification results may rapidly change, or flicker, when the video moves from the first frame, which may indicate the first object and the second object, to the second frame, which may indicate the third object. If multiple strided convolutional layers are used, this defect may accumulate rapidly.

Therefore embodiments are directed to a temporal fusion method, for example using the fusion modules 113, which may improve the temporal consistency of predictions from the DNNs used for dense prediction tasks for video. In embodiments, the fusion modules 113 to may be a plug-in component following some or all of the strided convolutional layers 112 in the encoder 110.

For example, the fusion module 113 according to embodiments may receive features extracted from the current frame and at least one neighboring frame. In embodiments, the at least one neighboring frame may include immediately preceding frames and the immediately subsequent frames, but embodiments are not limited thereto. For example, in some embodiments, the at least one neighboring frame may include any frames that are relevant to the underlying task, for example only preceding frames, only subsequent frames, or any frames within a predetermined time period.

In embodiments, the features extracted from the current frame may be concatenated with the features extracted from the at least one neighboring frame, and the concatenated features may be fed into the fusion module 113. In some embodiments, the fusion module 113 may generate a set of fusion weights having a same spatial shape as the feature maps from the frames. The feature maps may be fused as a weighted sum based on the predicted fusion weights to generate a fused feature map. The fused feature map may be fed back into the next layer in the plurality of backbone layers 111 following the strided convolution layer 113.

Some other approaches may relate to improving temporal consistency using fusion. However, in contrast to some of these approaches, embodiments are directed to addressing the problem via a change to the network architecture which provides a temporal consistency promoting loss based on optical flow prediction.

For example, some other approaches may use optical flow prediction to wrap the prediction of a neighboring frame, and may fuse the wrapped prediction and the current prediction using a gated recurrent block to generate the prediction. In contrast, embodiments may fuse the backbone feature maps without using the computationally-expensive optical flow computation and warping.

As another example, some other approaches may use a transformer network to aggregate and fuse information from neighboring frames so that the prediction for the current frame is improved and looks similar to its neighboring frames, thereby improving temporal consistency. In addition, such approaches may fuse the features generated by the backbone feature extractor. In contrast, embodiments may not use transformer network that incurs heavy matrix multiplications, and may fuse the features inside the encoder 110.

According to embodiments, the fusion module 113 may be used to correct the feature inconsistency between consecutive frames caused by the strided convolutional layers by aggregating features from consecutive frames. As a result, embodiments may not rely on motion estimation or optical flow which may introduce additional error. Because embodiments may not rely on motion estimation or optical flow estimation or warping operation or transformer operations, embodiments may reduce the amount of computational resources used in comparison with other approaches.

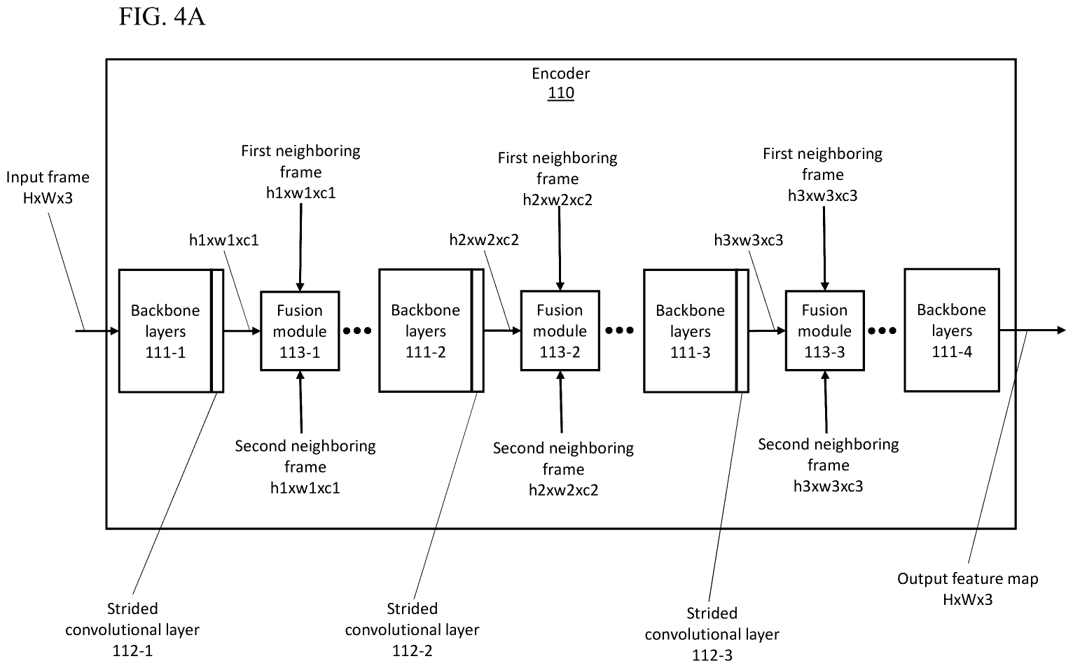

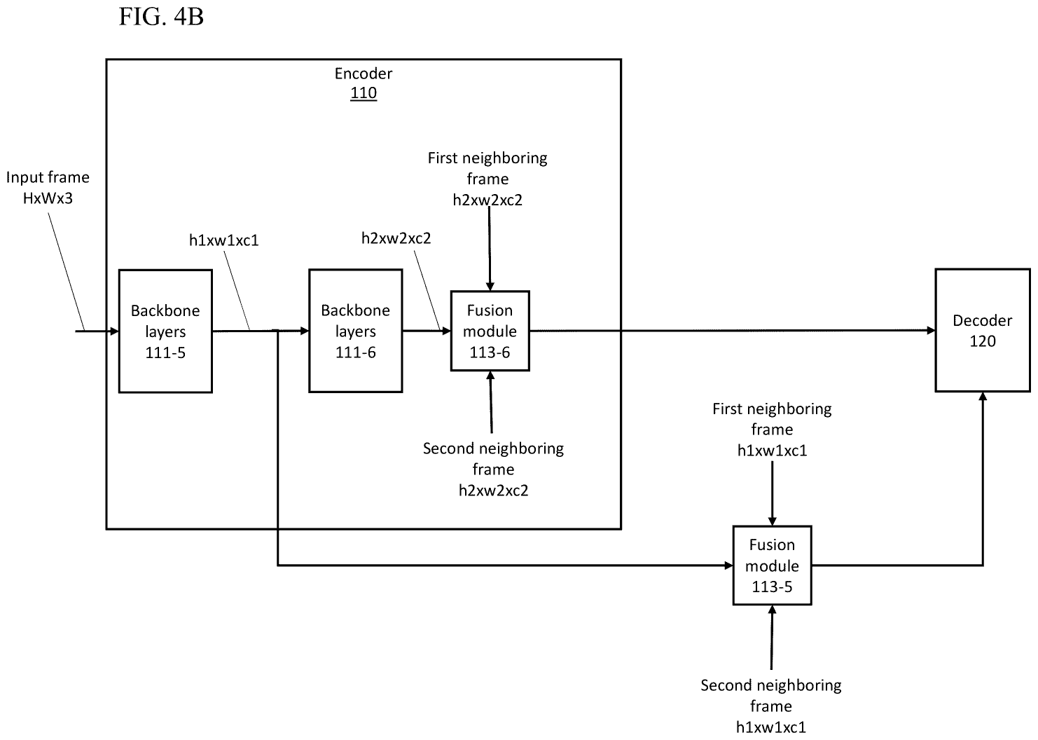

FIG. 4A is a block diagram showing an example arrangement of an encoder, according to embodiments. As can be seen in FIG. 4A, the encoder 110 may include a first, second, and third plurality of backbone layers 111-1, 111-2, and 111-3. First, second, and third strided convolutional layers 112-1, 112-2, and 112-3 may respectively follow each of the first, second, and third plurality of backbone layers 111-1, 111-2, and 111-3, and first, second, and third fusion modules 113-1, 113-2, and 113-3 may in turn follow the first, second, and third strided convolutional layers 112-1, 112-2, and 112-3. The encoder 110 may further include a fourth plurality of backbone layers 111-4.

As shown in FIG. 4A, the input frame may be a two-dimensional image frame with a height H and a width W, and may include pixel data for three channels, for example red, green, and blue channels for a color image. The first plurality of backbone layers 111-1 and the first strided convolutional layer 112-1 may produce a first feature map which may have downsampled dimensions h1 and w1, and features c1. For example, for an input image of 480×640 pixels and a downsampling rate of 2, the first feature map may have dimensions of 240×320 pixels, and any number of features may be generated for each pixel, for example 128 features. The first fusion module 113-1 may fuse the first feature map with corresponding neighboring first feature maps obtained from at least one neighboring frame, for example a first neighboring frame and a second neighboring frame, to generate a fused first feature map.

Similarly, the second plurality of backbone layers 111-2 and the second strided convolutional layer 112-2 may receive the fused first feature map, and may produce a second feature map which may have downsampled dimensions h2 and w2, and features c2. For example, for the second feature map may have dimensions of 120×160 pixels, and 64 features. The second fusion module 113-2 may fuse the second feature map with corresponding neighboring second feature maps obtained from the at least one neighboring frame to generate a fused second feature map.

The third plurality of backbone layers 111-2 and the third strided convolutional layer 112-3 may receive the fused second feature map, and may produce a third feature map which may have downsampled dimensions h3 and w3, and features c3. For example, for the second feature map may have dimensions of 60×80 pixels, and 32 features. The second fusion module 113-3 may fuse the third feature map with corresponding neighboring third feature maps obtained from the at least one neighboring frame to generate a fused third feature map.

In embodiments, a fourth plurality of backbone layers 111-4 may receive the fused third feature map, and may generate an output feature map. In embodiments, the output feature map may have the same dimensions as the input frame, but embodiments are not limited thereto. For example, the output feature map of the backbone layers 111-4 may have any shape or size depending on the task and the decoder corresponding to the encoder. In some embodiments, the output feature map may be smaller than H×W spatially, but with larger dimensionality in channels C. For example, if the input image is 480×640×3, then output of the last backbone layer could be 12×16×1024 or 24×32×512 depending on the design. The backbone typically would not output 480×640×3. The output of the backbone is not the final output of the semantic segmentation, it is an intermediate result.

Although FIG. 4A illustrates the fusion modules 113 as being included after each strided convolutional layer 112, embodiments are not limited thereto. For example, in some embodiments the fusion modules 113 may follow only some of the strided convolutional layers 112, or may be included within the plurality of backbone layers 111.

FIG. 4B is a block diagram showing another example arrangement of an encoder, according to embodiments. As can be seen in FIG. 4B, the encoder 110 may include an initial plurality of backbone layers 111-5, and a remaining plurality of backbone layers 111-6. In some embodiments, the initial plurality of backbone layers 111-5 may correspond to the first plurality of backbone layers 111-1 discussed above, and the remaining plurality of backbone layers 111-6 may correspond to one or more of the second, third, and fourth plurality of backbone layers 111-2, 111-3, and 111-4, but embodiments are not limited thereto. The encoder 110 may further include a first fusion module 113-5 and a second fusion module 113-6.

As shown in FIG. 4B, the initial plurality of backbone layers 111-5 may produce a first feature map which may have downsampled dimensions h1 and w1, and features c1. The first fusion module 113-5 may fuse the first feature map with corresponding neighboring first feature maps obtained from at least one neighboring frame, for example a first neighboring frame and a second neighboring frame, to generate a fused first feature map. The remaining plurality of backbone layers 111-6 may receive the first feature map, and may produce a second feature map which may have downsampled dimensions h2 and w2, and features c2. The second fusion module 113-6 may fuse the second feature map with corresponding neighboring second feature maps obtained from the at least one neighboring frame to generate a fused second feature map. Then, the fused first feature map and fused second feature map may be output, for example by being provided to the decoder 120. Accordingly, because the backbone layers are separated from the fusion modules, the output of the backbone layers may be used for other computer vision tasks, for example by being provided to multiple different decoders.

In embodiments, the fusion modules 113 may be implemented in many ways. For example, in some embodiments, the fusion modules 113 may perform the fusion by predicting fusion weights which indicate how much information from each of the input frame and the at least one neighboring frame to include in the fused feature map. In embodiments, the fusion modules 113 may include one or more residual blocks (RB) or inverted residual blocks (IRB) or other network architectures to predict the fusion weights. In embodiments, the fusion modules 113 may include depthwise-separable convolutional layers, which may reduce computational cost. In embodiments, the fusion modules 113 may use one or more transformer networks to predict fusion weights, or may perform the fusion without using fusion weights.

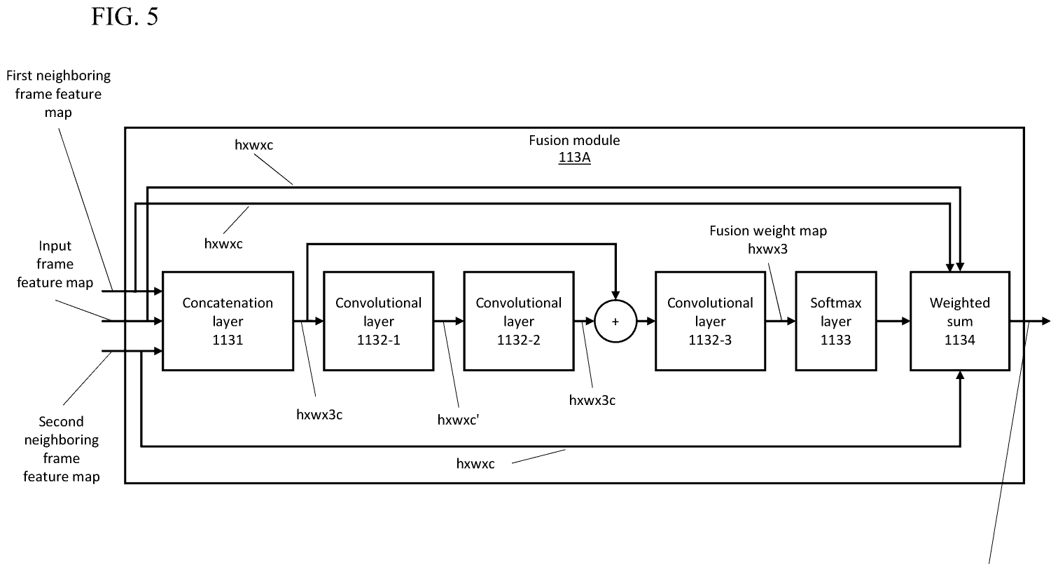

Example implementations of the fusion modules 113 are provided below with reference to FIGS. 5-7.

FIG. 5 is a block diagram of an example implementation of a fusion module, according to embodiments. As shown in FIG. 5, the fusion module 113A may include a concatenation layer 1131 which may concatenate the feature map corresponding to the input frame with the neighboring feature maps corresponding to the first neighboring frame and the second neighboring frame. The concatenated feature map may be provided to convolutional layers 1132-1, 1132-2, and 1132-3, which may be arranged as an inverted residual block, and which may produce intermediate feature maps of various dimensions. For example, c′ may denote a tunable parameter which may be modified to tune the performance of the fusion module 113A. The convolutional layers 1132-1, 1132-2, and 1132-3 may predict a fusion weight map, which may be provided to a softmax layer 1133 to normalize the weights, for example to ensure that they add up to a total of one. The fusion weight map may be provided to a weighted sum module 1134, which may compute a weighted sum of the feature map corresponding to the input frame and the neighboring feature maps corresponding to the neighboring frames based on the fusion weight map.

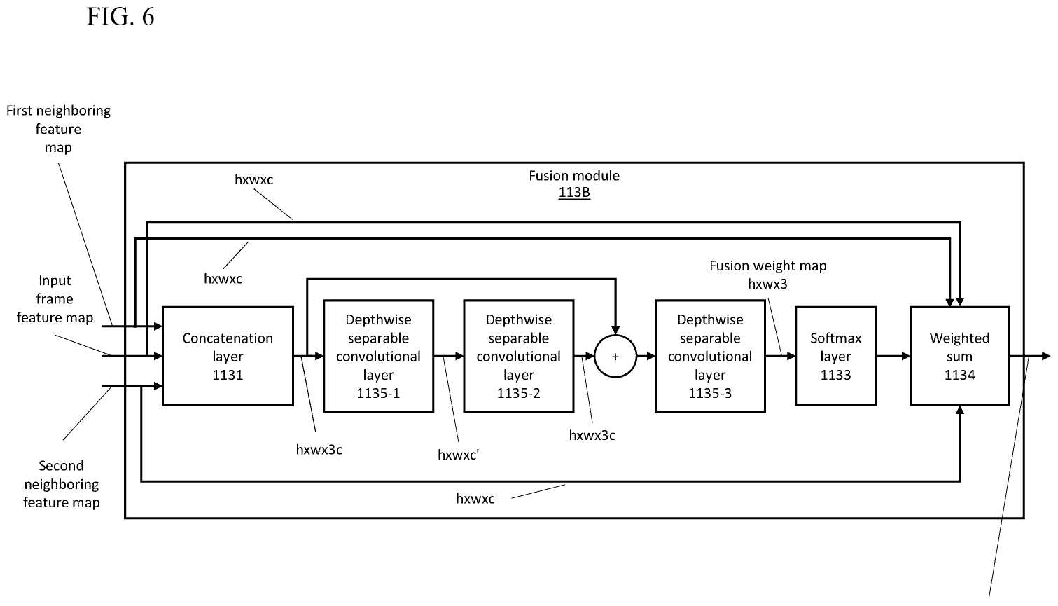

FIG. 6 is a block diagram of an example implementation of a fusion module, according to embodiments. As shown in FIG. 6, the fusion module 113B may be similar to the fusion module 113A illustrated in FIG. 5, except that the convolutional layers 1132-1, 1132-2, and 1132-3 may be replaced with depthwise-seperable convolutional layers 1135-1, 1135-2, and 1135-3.

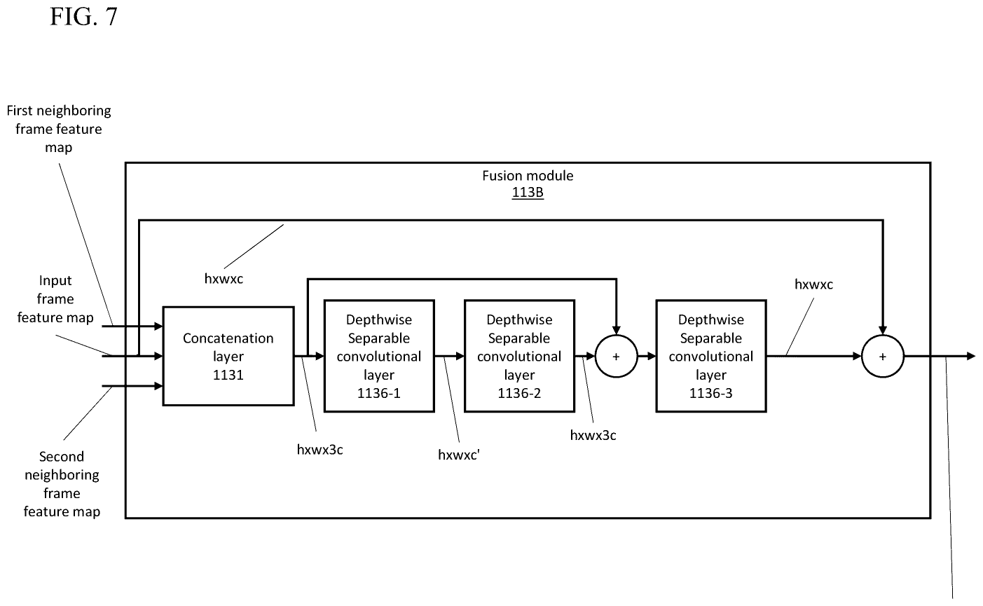

FIG. 7 is a block diagram of an example implementation of a fusion module, according to embodiments. As shown in FIG. 7, the fusion module 113C may differ from the fusion modules 113A and 113B discussed above, in that the fusion module 113C may perform fusion without using the softmax layer 1133 and the weighted sum module 1134.

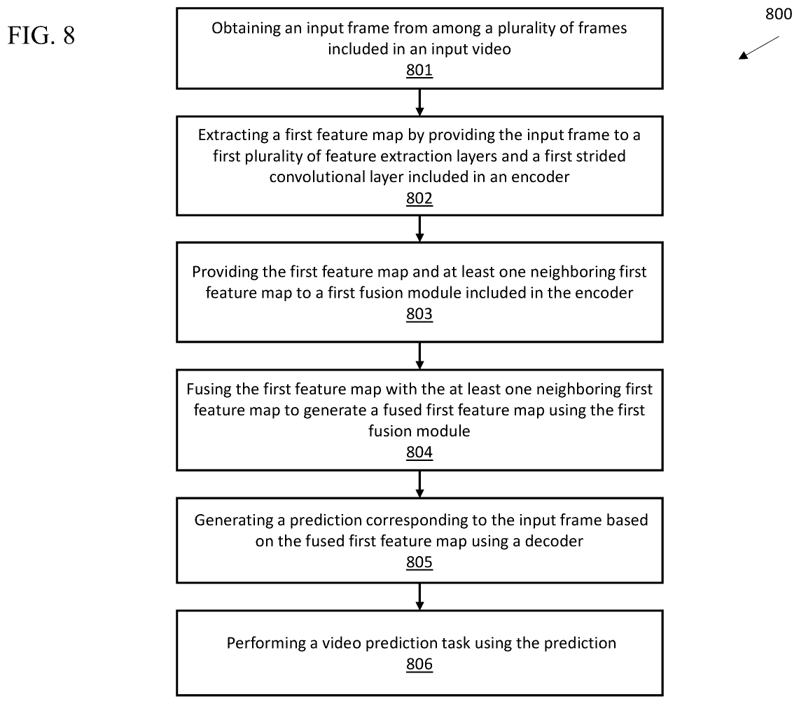

FIG. 8 is a flow chart of a process for performing video prediction, according to embodiments. In some implementations, one or more process blocks of FIG. 8 may be performed by one or more of the elements discussed above, for example one or more of the encoder 110 and any of the elements included therein.

As shown in FIG. 8, at operation 801 the process 800 may include obtaining an input frame from among a plurality of frames included in an input video. In some embodiments, the input frame may correspond to any of the input frames or current frames discussed above.

As further shown in FIG. 8, at operation 802 the process 800 may include extracting a first feature map by providing the input frame to a first plurality of feature extraction layers and a first strided convolutional layer included in an encoder. In some embodiments, the encoder may correspond to the encoder 110, the first plurality of feature extraction layer may correspond to the first backbone layers 111-1, and the first strided convolutional layer may correspond to the first strided convolutional layer 112-1 discussed above.

As further shown in FIG. 8, at operation 803 the process 800 may include providing the first feature map and at least one neighboring first feature map corresponding to at least one neighboring frame to a first fusion module included in the encoder. In some embodiments, the first fusion module may correspond to the first fusion module 113-1 discussed above.

As further shown in FIG. 8, at operation 804 the process 800 may include fusing the first feature map with the at least one neighboring first feature map to generate a fused first feature map using the first fusion module.

As further shown in FIG. 8, at operation 805 the process 800 may include generating a prediction corresponding to the input frame based on the fused first feature map using a decoder. In some embodiments, the decoder may correspond to the decoder 130 discussed above.

As further shown in FIG. 8, at operation 806 the process 800 may include performing a video prediction task using the prediction. In some embodiments, the video prediction task may be performed by the video processor discussed above.

In embodiments, the prediction may include at least one from among a mask, an image, and/or a tensor.

In embodiments, the video prediction task may include at least one from among video semantic segmentation, video panoptic segmentation, video instance segmentation, video super resolution processing, and video denoising.

In embodiments, the process 800 may further include extracting a second feature map by providing the fused first feature map to a second plurality of feature extraction layers and a second strided convolutional layer included in the encoder; providing the second feature map and at least one neighboring second feature map corresponding to the at least one neighboring frame to a second fusion module included in the encoder; and fusing the second feature map with the at least one neighboring second feature map to generate a fused second feature map using the second fusion module. In some embodiments, the prediction may be generated by the decoder based on the fused second feature map. In some embodiments, the second plurality of feature extraction layers may correspond to the second backbone layers 111-2, the second strided convolutional layer may correspond to the second strided convolutional layer 112-2, and the second fusion module may correspond to the second fusion module 113-2 discussed above.

In embodiments, the at least one neighboring frame may include at least one from among a first neighboring frame that temporally precedes the input frame, and a second neighboring frame that temporally succeeds the input frame.

In embodiments, the fusing may include predicting fusion weights corresponding to the input frame and the at least one neighboring frame using the first fusion module; and fusing the first feature map with the at least one neighboring first feature map using a weighted sum based on the fusion weights.

In embodiments, the first fusion module may include a plurality of convolutional layers arranged into at least one of a residual block (RB) and an inverted residual block (IRB), and the plurality of convolutional layers are used to predict the fusion weights, as shown for example in FIGS. 5 and 6.

In embodiments, the plurality of convolutional layers may be depthwise-separable, as shown for example in FIG. 6.

In embodiments, the fusing may include summing the first feature map with an output of the plurality of convolutional layers included in the fusion module, as shown for example in FIG. 7.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of processes process 800 may be performed in parallel.

Accordingly, embodiments are directed to temporal fusion for feature extractor networks, and a method to fix the feature inconsistency caused by the strided convolutional layers in the convolutional neural network for sequential information processing. In order to accomplish this, embodiments may include a fusion module that predicts fusion weights for temporal fusion. This fusion module may not rely on motion estimation or warping. According to embodiments, convolutional layers such as depthwise separable convolutional layers may receive the feature maps from an input frame and neighboring frames which temporally neighbor the input frame, and may predict fusion weights which may be used to fuse the feature maps from the input frame and the neighboring frames.

As a result, embodiments are directed to improving mean intersection over union (mIoU), mean temporal consistency (mTC) and mean video consistency (mVC) for dense prediction tasks such as video semantic segmentation. Embodiments may use less computational resources compared to other approaches involving motion estimation, optical flow estimation, transformer networks.

In embodiments, the feature extractor networks (e.g., the encoder 110) discussed above may be used to perform depth estimation tasks, for example by being included in a depth estimation system, examples of which are described below.

According to some embodiments, a first depth estimation system may include a motion compensator, a temporal attention subsystem, and a depth estimator. The motion compensator may receive a plurality of video frames including a first video frame, a second video frame which may also be referred to as a reference video frame, and a third video frame, which may represent successive frames (e.g., consecutive frames) of a video sequence.

In some embodiments, the motion compensator may be configured to compensate for pixel motions between the first to third video frames based on optical flow and to generate the first to third input frames (e.g., first to third warped frames). The motion compensator may align the temporal consistency between successive frames (e.g., adjacent frames). The motion compensator may include a spatial temporal transformer network and an image warper. In some examples, the spatial temporal transformer network may determine the optical flow (e.g., motion vector) of the pixels of the successive frames and may generate a first optical flow map indicating the optical flow of pixels from the first video frame to the second video frame, and a second optical flow map indicating the optical flow of pixels from the third video frame to the second video frame. The image warper may utilize the first and second optical flow maps to warp the input frames and generate first and third warped frames and (e.g., first and third RGB frames) that attempt to compensate for the movement of regions (e.g., pixels) of the input frames and. The warped frame may be the same as the input frame (e.g., the reference frame). Camera angle or perspective changes, occlusions, objects moving out of frame, etc. may result in inconsistencies in the warped frames. Such inconsistencies could confuse the depth estimation if the warped frames were fed directly to the depth estimator. However, the temporal attention subsystem may resolve this issue by extracting and emphasizing the consistent information among the motion-compensated warped frames.

As used herein, consistent information may refer to the characteristic of the same object (e.g., appearance, structure) being the same in successive (e.g., adjacent) frames. For example, when the motion of a moving car is estimated correctly by the motion compensator in consecutive frames, the shape and color of the car appearing in the successive (e.g., adjacent) warped frames may be similar. Consistency may be measured by a difference between the input feature maps to the temporal attention subsystem and the output feature map of the temporal attention subsystem.

In some embodiments, the temporal attention subsystem may identify which regions of a reference frame (e.g., the second/center video frame) are more important and should be given greater attention. In some examples, the temporal attention subsystem may identify differences between its input frames (e.g., the warped frames) and may assign weights/confidence values to each pixel of the frames based on temporal consistency. For example, when a region changes from one frame to the next, the confidence level for the pixels in that region may be lower. The weights/confidence values of the pixels together may make up a temporal attention map, which the temporal attention subsystem may use to reweigh the frames it receives (e.g., the warped frames).

According to some embodiments, the depth estimator may extract the depth of the reference frame (e.g., the second/center video frame) based on the output feature map of temporal attention subsystem.

According to embodiments, if a pixel in the output of the temporal attention subsystem is the same as the input, the difference map may be 0 for that pixel.

In embodiments, a second depth estimation system may be similar to the first depth estimation system discussion above, except that the arrangement order of the motion compensator, the temporal attention subsystem, and the depth estimator may be different. According to some embodiments, the second depth estimator may receive a plurality of video frames including the successive video frames from a video sequence, and may use a frame-by-frame depth estimation method (such as single image depth estimation, SIDE) and may generate first to third depth maps respectively corresponding to the first to third video frames.

In some embodiments, the motion compensator may receive the depth maps from the depth estimator. Thus, the motion compensator may be applied in the depth domain, rather than in the time domain as is the case with the motion compensator described above. In some embodiments, the spatial temporal transformer network may generate optical flow maps based on the depth maps, which the image warper may use to generate the warped estimated depth maps. According to some embodiments, then the temporal attention subsystem may be applied to extract the consistent information from the warped estimated depth maps, followed by a convolutional layer to obtain the final output, which may be the depth map corresponding to the reference frame (e.g., the second video frame). The convolutional layer may be used to convert the output feature map from the temporal attention subsystem to the depth map.

The depth estimation systems described above may be used based on the trade-off between the motion compensator and the depth estimator. The processing bottleneck of the first depth estimation system may be the motion compensator in the RGB domain, which may be relatively difficult to perform since the appearance of objects vary with the change of illumination and color distortion among different video frames. On the other hand, the processing bottleneck of the second depth estimation system may be the depth estimator. Motion compensation in the depth domain may be easier than in the RGB domain as the illumination and color distortion may be ignored. Thus, when the motion compensator is very accurate (e.g., when the accuracy of the optical flow estimation is above a set threshold), then the first depth estimation system may be utilized. When the depth estimator is very accurate (e.g., when it has accuracy greater than a set threshold), then the second depth estimation system may be utilized. According to some examples, devices (such as driver assist or autonomous vehicles) relying on depth estimation may include both of the first and second depth estimation systems described above, and may switch between the two systems as appropriate based on accuracy of optical flow estimation and depth estimation.

Examples of different approaches for implementing the temporal attention subsystem are described below, according to some embodiments of the present disclosure. According to some embodiments, the input frames to the temporal attention subsystem may be RGB video frames, but embodiments are not limited thereto, and the input frames may be warped frames or warped depth maps as described above.

According to some embodiments, the temporal attention subsystem may include a feature map extractor configured to convert the input frames into feature maps, which are processed by the temporal attention scaler for reweighting based on temporal attention consistency. The feature map extractor may be a convolutional layer applying a convolutional filter with learnable weights to the elements of the input frames. Here, the temporal attention subsystem may receive and process the whole of the input frames. Adding the feature map extractor before the temporal attention scaler may allow the temporal attention scaler to more readily cooperate with deep learning frameworks. However, embodiments of the present disclosure are not limited to utilizing a feature map extractor before the temporal attention scaler, and in some embodiments, the input frames may be fed directly to the temporal attention scaler.

In some embodiments, one or more elements included in the temporal attention subsystem and/or the feature map extractor may correspond to elements discussed above with respect to FIGS. 1, 4A-4B, and 5-7, but embodiments are not limited thereto. For example, in some embodiments, the fusion module 113 discussed above may be inserted into a convolutional encoder (e.g., the feature map extractor), and temporal attention may be used to further enhance the features for improved temporal consistency.

In some embodiments, the temporal attention subsystem may further include a patch extractor which may divide each of the input frames into a plurality of patches or subdivisions. Each patch of an input frame may be processed separately from the other patches of the input frame. For example, the patch extractor may divide the input frames into four patches, thus generating four sets of patches/sub-divisions. The first set of patches may include the first patch of each of the input frames, and the fourth set of patches may include the fourth patch of each of the input frames. Each patch set may be processed separately by a feature map extractor and temporal attention scaler. The different patch sets may be processed in parallel, or may be processed serially. The patch feature maps generated based on each patch set may be combined together to form a single feature map with temporal attention.

While the example discussed above relates to four sets of patches, embodiments of the present disclosure are not limited thereto. For example, the patch extractor may divide each input frame into any suitable number of patches. The temporal attention subsystem of may improve depth estimation accuracy as each processed patch set contains visual information that is better spatially correlated than that of an entire frame. For example, in a frame that includes a car driving on a road with the sky in the background occupying the top portion of the frame, the sky may only serve to complicate the depth estimation of the moving car, and may introduce inaccuracies. However, separating the sky and the car into different patches may allow the depth estimation system to provide a more accurate estimate of the depth of the car in the reference frame.

According to some embodiments, the temporal attention scaler may include a concatenation block, a reshape and transpose block, a temporal attention map generator, a multiplier, and a reshape block.

The temporal attention scaler may receive the first to third feature maps and concatenate them into a combined feature map. Each of the feature maps may have the same size C×W×H, where C indicates the number of channels (which, e.g., may correspond to color channels red, green, and blue), and W and H represent the width and height of the feature maps, which may be the same as the width and height dimensions of the input video frames. The combined feature map may have a size of 3C×W×H. As noted above, the feature maps may be generated from warped frames or from warped depth maps.

The reshape and transpose block may reshape the combined feature map from three dimensions (3D) to two dimensions (2D) to calculate a first reshaped map having a size of (3C)×(WH), and may transpose the first reshaped map to calculate a second reshaped map 264 having a size of (WH)×(3C). The temporal attention map generator may generate a temporal attention map based on the first reshaped map and the second reshaped map. The temporal attention map, which may be referred to as a similarity map, may include a plurality of weights Aᵢⱼ (where i and j are indices less than or equal to C, the number of channels) corresponding to different pairs of feature maps from among the first to third feature maps, where each weight indicates a similarity level of a corresponding pair of feature maps. In other words, each weight Aᵢⱼ may indicate the similarity between the frames that generate channels i and j. When i and j come from the same frame, the weight Aᵢⱼ may measure a kind of self-attention. For example, if C=3, the temporal attention map may have a size 9×9 (e.g., channels 1-3 belong to the first feature map, channel 4-6 belong to the second feature map, and channel 7-9 belong to the third feature map). The weight A₁₄ (i=1, j=4) in the temporal attention map may denote the similarity level between the first feature map and the second feature map. A higher weight value may indicate a higher similarity between corresponding feature maps. Each weight Aᵢⱼ of the plurality of weights of the temporal attention map may be expressed by Equation 1:

$${A}_{ij} = \frac{{s}^{{M}_{r}^{j} \cdot {M}_{r}^{i}}}{{\sum }_{i = 1}^{3 C} {s}^{{M}_{r}^{j} \cdot {M}_{r}^{i}}} \qquad ( Eq . 1 )$$

In Equation 1 above, Mᵣⁱ and Mᵣ^{j} may denote one dimensional vectors of the reshaped map, Mᵣⁱ·Mᵣ^{j} may denote the dot product between the two vectors, s may denote a learnable scaling factor, and i and j may denote index values greater than 0 and less than or equal to C.

The multiplier may perform a matrix multiplication between the temporal attention map and the reshaped map to generate a second reshaped map, which may be reshaped by the reshape block from 2D to 3D to generate the feature map with temporal attention having a size of 3C×W×H. The elements Y′ of the output feature map with temporal attention may be expressed by Equation 2:

$${Y}^{i} = {\sum }_{j = 1}^{3 C} ( {A}_{i j} {M}^{j} ) \qquad ( Eq . 2 )$$

In Equation 2 above, Y′ may denote a single channel feature map having a size of W×H.

According to some examples, the plurality of components of the depth estimation system, such as motion compensator, the temporal attention subsystem, and depth estimator may correspond to neural networks and/or deep neural networks (a deep neural network being a neural network that has more than one hidden layer, for use with deep learning techniques), and the process of generating said components may involve training the deep neural networks using training data and an algorithm, such as a back propagation algorithm. Training may include providing a large number of input video frames and depth maps for the input video frames with measured depth values. The neural networks then train based on this data to set the learnable values discussed above.

The operations performed by the depth estimation system according to some embodiments, may be performed by a processor that executes instructions stored on a processor memory. The instructions, when executed by the processor, cause the processor to perform the operations described above with respect to the depth estimation system.

While examples of the depth estimation system are described above as operating on a group of three input frames with the second frame acting as a reference frame, embodiments of the present disclosure are not limited thereto. For example, embodiments of the present disclosure may employ a group of an odd number of input frames (e.g., 5 or 7 input frames), where the center frame acts as the reference frame for which the depth estimation system generates a depth map. Further, such input frames may represent a sliding window of the frames of a video sequence. In some examples, increasing the number of input frames (e.g., from 3 to 5) may improve depth estimation accuracy.

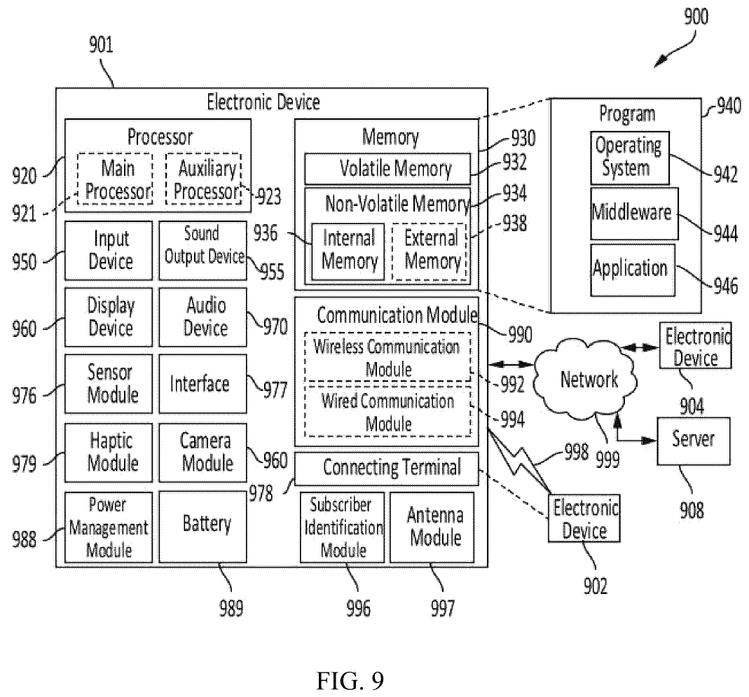

FIG. 9 is a block diagram of an electronic device in a network environment 900, according to an embodiment.

Referring to FIG. 9, an electronic device 901 in a network environment 900 may communicate with an electronic device 902 via a first network 998 (e.g., a short-range wireless communication network), or an electronic device 904 or a server 908 via a second network 999 (e.g., a long-range wireless communication network). The electronic device 901 may communicate with the electronic device 904 via the server 908. The electronic device 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) card 996, or an antenna module 997. In one embodiment, at least one (e.g., the display device 960 or the camera module 980) of the components may be omitted from the electronic device 901, or one or more other components may be added to the electronic device 901. Some of the components may be implemented as a single integrated circuit (IC). For example, the sensor module 976 (e.g., a fingerprint sensor, an iris sensor, or an illuminance sensor) may be embedded in the display device 960 (e.g., a display).

The processor 920 may execute software (e.g., a program 940) to control at least one other component (e.g., a hardware or a software component) of the electronic device 901 coupled with the processor 920 and may perform various data processing or computations.

As at least part of the data processing or computations, the processor 920 may load a command or data received from another component (e.g., the sensor module 976 or the communication module 990) in volatile memory 932, process the command or the data stored in the volatile memory 932, and store resulting data in non-volatile memory 934. The processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934. Non-volatile memory 934 may include internal memory 936 and/or external memory 938.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. The display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. The audio module 970 may obtain the sound via the input device 950 or output the sound via the sound output device 955 or a headphone of an external electronic device 902 directly (e.g., wired) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device 902 directly (e.g., wired) or wirelessly. The interface 977 may include, for example, a high-definition multimedia interface (HDMI), a universal serial bus (USB) interface, a secure digital (SD) card interface, or an audio interface.

A connecting terminal 978 may include a connector via which the electronic device 901 may be physically connected with the external electronic device 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power supplied to the electronic device 901. The power management module 988 may be implemented as at least part of, for example, a power management integrated circuit (PMIC).

The battery 989 may supply power to at least one component of the electronic device 901. The battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the AP) and supports a direct (e.g., wired) communication or a wireless communication. The communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as BLUETOOTH™, wireless-fidelity (Wi-Fi) direct, or a standard of the Infrared Data Association (IrDA)) or the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. The antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

Commands or data may be transmitted or received between the electronic device 901 and the external electronic device 904 via the server 908 coupled with the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 701 may provide the outcome, with or without further processing of the outcome, as at least part of a reply to the request. To that end, a cloud computing, distributed computing, or client-server computing technology may be used, for example.

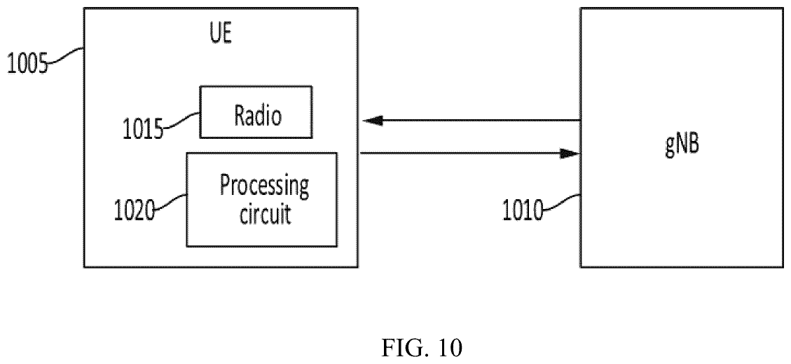

FIG. 10 shows a system including a UE 1005 and a gNB 1010, in communication with each other. The UE may include a radio 815 and a processing circuit (or a means for processing) 1020, which may perform various methods disclosed herein, e.g., the method illustrated in FIGS. 2 and 8A-8C. For example, the processing circuit 1020 may receive, via the radio 1015, transmissions from the network node (gNB) 1010, and the processing circuit 1020 may transmit, via the radio 1015, signals to the gNB 1010.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

1. A method of performing video prediction, the method being executed by at least one processor and comprising:
obtaining an input frame from among a plurality of frames included in an input video;
extracting a first feature map by providing the input frame to a first plurality of feature extraction layers and a first strided convolutional layer included in an encoder;
providing the first feature map and at least one neighboring first feature map corresponding to at least one neighboring frame to a first fusion module included in the encoder;
fusing the first feature map with the at least one neighboring first feature map to generate a fused first feature map using the first fusion module;
generating a prediction corresponding to the input frame based on the fused first feature map using a decoder; and
performing a video prediction task using the prediction.

2. The method of claim 1, wherein the prediction comprises any one or any combination of a mask, an image, and a tensor.

3. The method of claim 1, wherein the video prediction task comprises at least one from among video semantic segmentation, video panoptic segmentation, video instance segmentation, video super resolution processing, and video denoising.

4. The method of claim 1, further comprising:
extracting a second feature map by providing the fused first feature map to a second plurality of feature extraction layers and a second strided convolutional layer included in the encoder;
providing the second feature map and at least one neighboring second feature map corresponding to the at least one neighboring frame to a second fusion module included in the encoder; and
fusing the second feature map with the at least one neighboring second feature map to generate a fused second feature map using the second fusion module,
wherein the prediction is generated by the decoder based on the fused second feature map.

5. The method of claim 1, wherein the at least one neighboring frame comprises at least one from among a first neighboring frame that temporally precedes the input frame, and a second neighboring frame that temporally succeeds the input frame.

6. The method of claim 1, wherein the fusing comprises:
predicting fusion weights corresponding to the input frame and the at least one neighboring frame using the first fusion module; and
fusing the first feature map with the at least one neighboring first feature map using a weighted sum based on the fusion weights.

7. The method of claim 6, wherein the first fusion module comprises a plurality of convolutional layers arranged into at least one of a residual block (RB) and an inverted residual block (IRB), and
wherein the plurality of convolutional layers are used to predict the fusion weights.

8. (canceled)

9. The method of claim 1, wherein the first fusion module comprises a plurality of convolutional layers, and
wherein the fusing comprises summing the first feature map with an output of the plurality of convolutional layers.

10. A system for performing video prediction, the system comprising:
an encoder configured to:
obtain an input frame from among a plurality of frames included in an input video,
extract a first feature map by providing the input frame to a first plurality of feature extraction layers and a first strided convolutional layer included in the encoder,
provide the first feature map and at least one neighboring first feature map corresponding to at least one neighboring frame to a first fusion module included in the encoder,
fuse the first feature map with the at least one neighboring first feature map to generate a fused first feature map using the first fusion module;
a decoder configured to generate a prediction corresponding to the input frame based on the fused first feature map; and
at least one video processor configured to perform a video prediction task using the prediction.

11. The system of claim 10, wherein the prediction comprises any one or any combination of among a mask, an image, and a tensor.

12. The system of claim 10, wherein the video prediction task comprises at least one from among video semantic segmentation, video super resolution processing, and video denoising.

13. The system of claim 10,
wherein the encoder is further configured to:
extract a second feature map by providing the fused first feature map to a second plurality of feature extraction layers and a second strided convolutional layer included in the encoder;
provide the second feature map and at least one neighboring second feature map corresponding to the at least one neighboring frame to a second fusion module included in the encoder; and
fuse the second feature map with the at least one neighboring second feature map to generate a fused second feature map using the second fusion module,
wherein the prediction is generated by the decoder based on the fused second feature map.

14. The system of claim 10, wherein the at least one neighboring frame comprises at least one from among a first neighboring frame that temporally precedes the input frame, and a second neighboring frame that temporally succeeds the input frame.

15. The system of claim 10, wherein to perform the fusing, the encoder is further configured to:
predict fusion weights corresponding to the input frame and the at least one neighboring frame using the first fusion module; and
fuse the first feature map with the at least one neighboring first feature map using a weighted sum based on the fusion weights.

16. The system of claim 15, wherein the first fusion module comprises a plurality of convolutional layers arranged into at least one of a residual block (RB) and an inverted residual block (IRB), and
wherein the plurality of convolutional layers are used to predict the fusion weights.

17. (canceled)

18. The system of claim 10, wherein the first fusion module comprises a plurality of convolutional layers, and
wherein the fusing comprises summing the first feature map with an output of the plurality of convolutional layers.

19. A non-transitory computer-readable medium configured to store instructions which, when executed by at least one processor of an electronic device for performing video prediction, causes the at least one processor to:
obtain an input frame from among a plurality of frames included in an input video;
extracting a first feature map by providing the input frame to a first plurality of feature extraction layers and a first strided convolutional layer included in an encoder;
provide the first feature map and at least one neighboring first feature map corresponding to at least one neighboring frame to a first fusion module included in the encoder;
fuse the first feature map with the at least one neighboring first feature map to generate a fused first feature map using the first fusion module;
generate a prediction corresponding to the input frame based on the fused first feature map using a decoder; and
perform a video prediction task using the prediction.

20. The non-transitory computer-readable medium of claim 19, wherein the prediction comprises any one or any combination of among a mask, an image, and a tensor.

21. The non-transitory computer-readable medium of claim 19,
wherein to perform the fusing, the at least one processor is further configured to:
predict fusion weights corresponding to the input frame and the at least one neighboring frame using the first fusion module; and
fuse the first feature map with the at least one neighboring first feature map using a weighted sum based on the fusion weights,
wherein the first fusion module comprises a plurality of convolutional layers arranged into at least one of a residual block (RB) and an inverted residual block (IRB), and
wherein the plurality of convolutional layers are used to predict the fusion weights.

22. (canceled)

23. The non-transitory computer-readable medium of claim 19, wherein the first fusion module comprises a plurality of convolutional layers, and
wherein the fusing comprises summing the first feature map with an output of the plurality of convolutional layers.
